(19) United States
(12) Patent Application Publication
(10) Pub. No.: US 2006/0292468 A1
(43) Pub. Date: Dec. 28, 2006

(54) Electrophotographic photoreceptor for blue-violet exposure light source and electrophotographic imaging apparatus employing the photoreceptor

(75) Inventors: Saburo Yokota, Suwon-si (KR); Beom-jun Kim, Yongin-si (KR); Moto Makino, Suwon-si (KR); Hwan-koo Lee, Suwon-si (KR); Seung-ju Kim, Suwon-si (KR); Ji-Young Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/471,533

(22) Filed: Jun. 21, 2006

(30) Foreign Application Priority Data
Jun. 27, 2005 (KR) 10-2005-0055939

(51) Int. Cl. G03G 5/047

(52) U.S. Cl. 430/58.65; 430/58.05; 430/56; 430/59.5; 430/58.5

(57) ABSTRACT

An electrophotographic photoreceptor and an electrophotographic imaging apparatus employing the photoreceptor are disclosed. The electrophotographic photoreceptor includes an electrically conductive substrate and a photosensitive layer formed on the electrically conductive substrate, wherein a latent image is formed on the photosensitive layer using a blue-violet exposure light source having a wavelength of 380 to 450 nm. The outer surface of the photosensitive layer includes a charge generating material, a charge transporting material, and a binder resin. The light transmittance of the photosensitive layer is 1.0×10⁻¹ to 1.0×10⁻³ in the light exposure wavelength. The electrophotographic photoreceptor can provide high quality images with high resolution using the blue-violet exposure light source.

### CROSS-REFERENCE TO RELATED PATENT APPLICATION

This application claims the benefit of Korean Patent Application No. 10-2005-0055939, filed on Jun. 27, 2005, in the Korean Intellectual Property Office, the disclosure of which is incorporated herein by reference in its entirety.

### BACKGROUND OF THE INVENTION

1. Field of the Invention

The present invention relates to an electrophotographic photoreceptor and an electrophotographic imaging apparatus employing the photoreceptor. More particularly, the invention is directed to an electrophotographic photoreceptor using blue-violet light as an exposure light source to obtain high resolution and an electrophotographic imaging apparatus employing the photoreceptor.

2. Description of the Related Art

From the early days, AlGaAs/GaAs semiconductor lasers having oscillation wavelengths in a near-infrared region near 800 nm have been widely used as an exposure light source in electrophotographic imaging apparatuses. Despite the fact that the AlGaAs/GaAs semiconductor lasers emit the longer wavelength range than visible light wavelength range to which most of conventional electrophotographic photoreceptors are sensitive, the semiconductor lasers have been selected because semiconductor lasers were not available that oscillate in the short wavelength range in a stable manner. Accordingly, electrophotographic photoreceptors for laser printers have been developed differently from those for copy machines. That is, conventional inorganic electrophotographic photoreceptors have not been used, and multilayer type electrophotographic photoreceptors in which an organic compound sensitive to the longer wavelength range is used in a charge generating layer have been mainly used. As described above, in the electrophotographic imaging apparatus, the exposure light source and the electrophotographic photoreceptor have been developed with a close relationship.

Recently, high resolution printing has been actively researched to increase the printing quality of electrophotographic imaging apparatuses. Optical approaches to accomplish this objective are relatively easy. That is, writing density will be increased by reducing the spot diameter of a light exposure beam so that the resolution is enhanced. However, in semiconductor lasers having a near-infrared oscillation wavelength, which is widely being used as an exposure light source, it is difficult to obtain clear spot by decreasing the beam diameter because of diffraction limit of the laser. If a light source having a short wavelength is employed, this limitation may be solved, because the spot diameter D is proportional to the wavelength λ of a laser according to the equation below
D=1.22λ/NA
where NA denote the number of lens apertures.

Meanwhile, light emitting diodes (LEDs) and semiconductor lasers having short oscillation wavelengths have been continuously developed so that red semiconductor lasers having near 650 nm oscillation wavelengths were practically used from early 1990s'. In 1991, ZnSe laser emitting at 450 nm was introduced, but was not been practically used due to its short lifetime. However, an effective GaN blue LED was developed in 1993, and a GaN blue-violet semiconductor laser emitting at about 410 nm and having long lifetime was developed in 1995. These are being practically used as a light source in a blue display apparatus or a high density optical disk.

Japanese Laid-Open Patent Application Hei 9-240051 discloses a technology using an electrophotographic photoreceptor, which includes a photosensitive layer having a charge generating material as the surface layer thereof, in an electrophotographic imaging apparatus using a blue semiconductor laser having a wavelength of 400 to 500 nm. In a conventional photoreceptor in which a charge transporting layer is laminated at its surface layer, this technology suggests solutions for the insufficient photosensitivity caused by the absorption of blue light in the charge transporting layer and for the resolution degradation due to charge dispersion generated when the charges migrate in the charge transporting layer.

As the photoreceptors having a charge generating material in the surface layer thereof, there are a monolayer type photoreceptor, which includes an organic pigment as a charge generating material dispersed in a binder resin, and a multilayer type photoreceptor in which a thin charge generating layer including a charge generating material dispersed in a binder resin is formed on a charge transporting layer. In these photoreceptors, the amount of the charge generating material should be large to obtain good electrophotographic properties. However, rapid degradation due to, for example, corona discharging, or the deterioration of the mechanical durability thereof may occur. Alternatively, there are a monolayer type photoreceptor, which includes a charge generating material and a charge transporting material dispersed in a binder resin, and a multilayer type photoreceptor in which a thick charge generating layer including a charge generating material and a charge transporting material dispersed in a binder resin is formed on a charge transporting layer. Since these photoreceptors includes the charge generating material together with the charge transporting material in the surface layer thereof, the amount of the charge generating material can be maintained relatively small. Accordingly, these photoreceptors are less affected by the corona discharging and have high mechanical durability due to the increase of the amount of the binder resin. Therefore, these photoreceptors are more practical.

However, when the electrophotographic photoreceptor having a photosensitive layer at the surface which includes a charge generating material together with a charge transporting material as disclosed in Japanese Laid-Open Patent Application Hei 9-240051 is applied to an electrophotographic imaging apparatus using a blue-violet light source, it was shown that the electrophotographic imaging apparatus cannot provide printed images with sufficient high resolution than had been expected, since the amount of the charge generating material in the surface layer is small, the radiated light may penetrate inside the photosensitive layer to some extent, and then is scattered and dispersed. Moreover, in the blue-violet light range, since the charge transporting material as well as charge generating material absorb light, the amount of light absorption cannot be controlled by simply adjusting the amount of the charge generating material. Accordingly, a photoreceptor, prepared in production example 3 of the patent document, having a charge transporting material in the surface layer thereof shows a lower photosensitivity than the other two photoreceptors prepared in production examples 1 and 2 of the patent document, which do not include the charge transporting material in the surface layer thereof. This patent document does not teach or suggest the relationship between the resolution of printed image and the light transmittance of the photosensitive layer. Accordingly, the electrophotographic apparatus using a blue-violet semiconductor laser should be further developed to obtain printed images with high resolution.

Japanese Laid-Open Patent Application Hei 8-106165 relates to a monolayer type electrophotographic photoreceptor that can provide an image without interference fringes using an electrophotographic apparatus in which coherent light is used as a light exposure light. For this, the patent document discloses a monolayer type electrophotographic photoreceptor having a charge generating material, an organic acceptor compound, and a hole transporting material on a conductive substrate, wherein the transmittance for light measured at the wavelength of the exposure light is equal to or less than 10%. However, this technology mainly concerns increasing light absorption by the charge generating material to prevent image defects such as interference fringes when a near-infrared wavelength of 780 nm is used as a light source for exposure and uses an acceptor compound, which has high light absorption in a blue-violet light range. Thus, effective light energy is reduced due to the light absorption by the acceptor compound so that the photosensitivity is insufficient in the blue-violet light range.

### SUMMARY OF THE INVENTION

The present invention provides an electrophotographic photoreceptor which produces printed images with high resolution even when using blue-violet light as an exposure light source

The present invention also provides an electrophotographic imaging apparatus employing the electrophotographic photoreceptor.

According to an aspect of the present invention, an electrophotographic photoreceptor is provided comprising an electrically conductive substrate and a photosensitive layer formed on the electrically conductive substrate, wherein a latent image is formed on the photosensitive layer using a blue-violet exposure light source having a wavelength of about 380 to about 450 nm, the outer surface of the photosensitive layer includes a charge generating material, a charge transporting material, and a binder resin, and the light transmittance of the photosensitive layer is 1.0×10⁻¹ to 1.0×10⁻³ in the light exposure wavelength.

According to another aspect of the present invention, there is provided an electrophotographic imaging apparatus is provided comprising:

an electrophotographic photoreceptor having an electrically conductive substrate and a photosensitive layer formed on the electrically conductive substrate;

a charging apparatus for charging the photosensitive layer of the electrophotographic photoreceptor;

a light exposure apparatus for forming an electrostatic latent image on the surface of the photosensitive layer of the electrophotographic photoreceptor by light exposure using a laser; and

a developing apparatus for developing the electrostatic latent image,

wherein the latent image is formed on the photosensitive layer using a blue-violet exposure light source having a wavelength of about 380 to about 450 nm, the outer surface of the photosensitive layer includes a charge generating material, a charge transporting material, and a binder resin, and the light transmittance of the photosensitive layer is 1.0×10⁻¹ to 1.0×10⁻³ in the light exposure wavelength.

According to an embodiment of the present invention, the photosensitive layer is a monolayer type photosensitive layer, and comprises the charge generating material and the charge transporting material dispersed or dissolved in the binder resin.

According to another embodiment of the present invention, the photosensitive layer is a multilayer type photosensitive layer, and comprises:

a charge transporting layer having the charge transporting material dispersed or dissolved in the binder resin; and

a charge generating layer which is formed on the charge transporting layer and has the charge generating material and the charge transporting material dispersed or dissolved in the binder resin.

The electrophotographic imaging apparatus according to the present invention uses blue-violet light having an oscillation wavelength of 380 to 450 nm as a light source, the dispersion of radiating light spots is significantly reduced, thereby effectively producing printed images with high resolution. In addition, the electrophotographic photoreceptor according to the present invention used with the laser exposure light source of blue-violet light includes the charge generating material on the light incident surface of the photosensitive layer thereof, thereby being able to obtain high resolution effectively in view of the structure of the photosensitive layer. In addition, in the electrophotographic photoreceptor according to the present invention, the light transmittance of the oscillation wavelength of the exposure light source is set in a predetermined range so that the resolution degradation due to the photoreceptor can be minimized and good photosensitive and mechanical properties can be provided. Accordingly, the photoreceptor according to the present invention is specifically effective as an electrophotographic photoreceptor for a blue-violet light source.

These and other aspects of the invention will become apparent from the following detailed description of the invention which will become apparent from the following detailed description of the invention in conjunction with the drawings which disclose various embodiments of the invention.

### BRIEF DESCRIPTION OF THE DRAWINGS

The above and other features and advantages of the present invention will become more apparent by describing in detail exemplary embodiments thereof with reference to the attached drawings in which:

FIG. 1 is a cross-sectional view of an electrophotographic photoreceptor having a monolayer type photosensitive layer, according to an embodiment of the present invention; and

FIG. 2 is a cross-sectional view of an electrophotographic photoreceptor having a multilayer type photosensitive layer, according to another embodiment of the present invention

### DETAILED DESCRIPTION OF THE INVENTION

An electrophotographic photoreceptor according to the present invention and an electrophotographic imaging apparatus employing the same will now be described in detail.

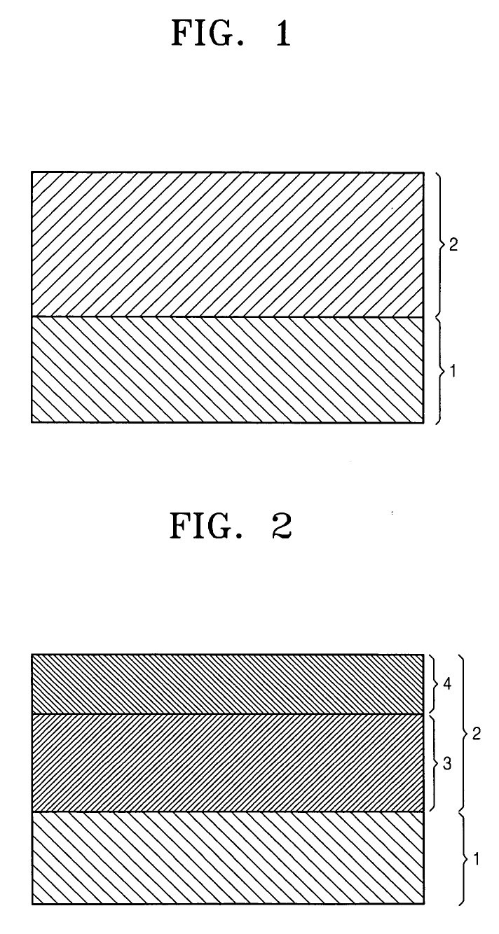

FIG. 1 is a cross-sectional view of an electrophotographic photoreceptor having a monolayer type photosensitive layer, according to an embodiment of the present invention. Referring to FIG. 1, a monolayer type photosensitive layer in which a charge generating material and a charge transporting material are dispersed in a binder resin, is formed on an electrically conductive substrate. The thickness of the monolayered photosensitive layer is generally about 5-50 μm, specifically 10-40 μm. When the thickness of the monolayered photosensitive layer is less than 5 μm, the charging capability and sensitivity may be lowered. When the thickness of the monolayered photosensitive layer is greater than 50 μm, a residual potential may increase or response speed may decrease.

FIG. 2 is a cross-sectional view of an electrophotographic photoreceptor having a multilayer type photosensitive layer, according to another embodiment of the present invention. Referring to FIG. 2, a multilayer type photosensitive layer in which a charge transporting layer having charge transporting materials dispersed in a binder resin and a charge generating layer having a charge generating material dispersed in a binder resin are sequentially stacked is formed on an electrically conductive substrate.

The thickness of the charge generating layer may be 1 to 20 μm, for example, 2 to 10 μm. When the thickness of the charge generating layer is less than 1 μm, the photosensitivity and the mechanical durability may be insufficient. When the thickness is greater than 20 μm, the thickness of the charge generating layer and the entire thickness of the photosensitive layer having the charge transporting layer are too thick so that electrophotographic properties may be degraded.

The thickness of the charge transporting layer may be 2 to 100 μm, for example, 5 to 50 μm, such as 10 to 40 μm. When the thickness of the charge transporting layer is less than 2 μm, the thickness is too thin to provide sufficient durability. When the thickness of the charge transporting layer is greater than 100 μm, the physical abrasion resistance tends to increase but the printing quality tends to be degraded.

Besides the photosensitive layer, other functional layers, for example, an intermediate layer, a undercoat layer, a surface protecting layer also may be formed.

The electrically conductive substrate can be formed from any electroconductive material, for example, metal or electrically conductive polymers, and is produced in the form of a plate, a disk, a sheet, a belt, or a drum. Examples of the metals include aluminum, vanadium, nickel, copper, zinc, palladium, indium, tin, platinum, stainless steel, chrome, and so forth. Examples of the polymers include polyester resin, polycarbonate resin, polyamide resin, polyimide resin, mixtures thereof, and a copolymer thereof having an electrically conductive material dispersed therein, such as electrically conductive carbon, tin oxide and indium oxide. An organic polymer sheet formed by depositing or laminating a metal sheet or metal may be employed.

The charge generating material used in the photosensitive layer may be formed from any material sensitive to blue-violet light used as a light source. For example, various organic pigments or organic dyes such as azo-based pigments, quinone-based pigments, perylene-based pigments, indigo-based pigments, thioindigo-based pigments, bisbenzoimidazole-based pigments, phthalocyanine-based pigments, quinacridone-based pigments, quinoline-based pigments, lake-based pigments, azolake-based pigments, anthraquinone-based pigments, oxazine-based pigments, dioxazine-based pigments, triphenylmethane-based pigments, azulenium dyes, squarylium dyes, pyrylium dyes, triallylmethane-based dyes, xanthene-based dyes, thiazine-based dyes, cyanine-based dyes, perinone-based compounds, polycycloquinone compounds, pyrrolopyrrol compounds, or naphthalocyanine compounds, or inorganic materials such as amorphous silicon, amorphous selenium, tellurium, selenium tellurium alloys, cadmium sulfide, antimony sulfide, zinc oxide, or zinc sulfide may be used. The charge generating material is not limited to the materials listed herein, and, it may be used alone or in combination of two or more.

In the electrophotographic photoreceptor according to the present invention, a hole transporting material and/or electron transporting material may be used as the charge transporting material.

The hole transporting material used for the photosensitive layer includes low molecular compounds, for example, pyrene-based, carbazole-based, hydrazone-based, oxazole-based, oxadiazole-based, pyrazolin-based, arylamine-based, arylmethane-based, benzidine-based, thiazole-based, stilbene-based, and butadiene-based compounds. The hole transporting material used in the photosensitive layer may be polymer compounds, for example, poly-N-vinylcarbazole, halogenated poly-N-vinylcarbazole, polyvinylpyrene, polyvinylanthracene, polyvinylacridine, pyrene-formaldehyde resin, ethylcarbazole-formaldehyde resin, triphenylmethane polymer, and polysilanes.

The electron transporting material may be, for example, benzoquinone-based, tetracyanoethylene-based, tetracyanoquinodimethane-based, fluorenone-based, xanthone-based, phenanthraquinone-based, phthalic anhydride-based, diphenoquinone-based, stilbenequinone-based, naphthalene-based, and thiopyran-based low molecular compounds which have electron absorbing property. However, the present invention is not limited thereto, electron transporting polymer compounds or pigments having n-type semiconductor characteristic may also be used.

In the electrophotographic photoreceptor according to the present invention, the charge transporting material may be used alone or in combination of two or more. In one embodiment, the charge generating material comprises a titanyl phthalocyanine-based compound. The charge transporting material can comprise together a hole transporting material comprising an arylamine-based compound, and an electron transporting material comprising a naphthalenetetracarboxylic acid diimide-based compound.

In the electrophotographic photoreceptor according to the present invention, the binder resin may be a polymer which can form an electrically insulating film. The polymers may be, but are not limited to, for example, polycarbonate, polyester, methacryl resin, acryl resin, polyvinyl chloride, polyvinylidene chloride, polystyrene, polyvinyl acetate, styrene-butadiene copolymer, vinylidene chloride-acrylonitrile polymer, vinyl chloride-vinyl acetate copolymer, vinyl chloride-vinyl acetate-maleic anhydride copolymer, silicone resin, silicone-alkyd resin, phenol-formaldehyde resin, styrene-alkyd resin, poly-N-vinyl carbazole, polyvinyl butyral, polyvinyl formal, polysulfone, casein, gelatin, polyvinyl alcohol, ethyl cellulose, phenol resin, polyamide, carboxymethyl cellulose, vinylidene chloride-based polymer latex, and polyurethane. The binder resin may be used alone or in combination of two or more.

The present inventors have found that a polycarbonate resin is preferable for use as a binder resin for forming a charge transporting layer or monolayer type photosensitive layer. In particular, polycarbonate-Z derived from cyclohexylidene bisphenol is preferable to polycarbonate-A derived from bisphenol A or polycarbonate-C derived from methylbisphenol-A because the high glass transition temperature and high abrasion resistance thereof can be used.

Additives, for example, a dispersion stabilizer, a plasticizer, a surface modifier, an antioxidant, and a light stabilizer may be used with the binder resin.

Examples of the plasticizer include any known plasticizer, for example, biphenyl, biphenyl chloride, terphenyl, dibutyl phthalate, diethyleneglycol phthalate, dioctyl phthalate, triphenyl phosphoric acid, methylnaphthalene, benzophenone, chlorinated paraffins, polypropylene, polystyrene, and various fluorine hydrocarbons, but are not limited thereto.

Examples of the surface modifier include any known surface modifier, for example, a silicone oil, and a fluorine resin, but are not limited thereto.

Examples of the antioxidant include any known antioxidant, for example, hindered phenol-based compounds, sulfur-based compounds, esters of phosphonic acid, esters of hypophosphoric acid, and amine-based compounds, but are not limited thereto.

Examples of the light stabilizer include any known light stabilizer, for example, benzotriazole-based compounds, benzophenone-based compounds, and hindered amine-based compounds, but are not limited thereto.

The photosensitive layer is formed using, for example, a dip coating method, a ring coating method, a roll coating method, or a spray coating method. For the monolayer type photoreceptor, a monolayer type photosensitive layer forming composition in which the binder resin, the charge generating material, and the hole transporting material and/or the electron transporting material are dispersed or dissolved in an organic solvent is coated on an electrically conductive substrate, and dried at about 40 to 200° C. for about 0.1 to 5 hours, thereby forming a monolayer type photosensitive layer. For the multilayer type photoreceptor, a charge transporting layer forming composition in which the binder resin, and the hole transporting material and/or the electron transporting material are dispersed or dissolved in an organic solvent is coated on an electrically conductive substrate, and dried at about 40 to 200° C. for about 0.1 to 5 hours, thereby forming a charge transporting layer. Next, a charge generating layer forming composition in which the charge generating material, the hole transporting material and/or the electron transporting material, and the binder resin are dispersed or dissolved in an organic solvent are applied onto the charge transporting layer, and dried at about 40 to 200° C. for about 0.1 to 5 hours, thereby forming a charge generating layer.

The amounts of the charge generating material, the hole transporting material, the electron transporting material, and the binder resin are not specifically limited, may be selected from a range in which the light transmittance of the photosensitive layer is 1.0×10⁻¹ to 1.0×10⁻³ within a wavelength range of the light exposure.

The type of the organic solvent depends on the type of the binder resin so that an optimum organic solvent may be selected. The organic solvent may be, for example, alcohols such as methanol, ethanol, and n-propanol; ketones such as acetone, methyl ethyl ketone, and cyclohexanone; amides such as N, N-dimethyl formamide and N, N-dimethyl acetamide; ethers such as tetrahydrofuran, dioxane, dioxolane, and methyl cellosolve; esters such as methyl acetate and ethyl acetate; sulfoxides or sulfones such as dimethyl sulfoxide and sulfolane; halogenated aliphatic hydrocarbons such as methylene chloride, chloroform, tetrachloromethane, and trichloroethane; aromatics such as benzene, toluene, xylene, monochlorobenzene, and dichlorobenzene.

The light transmittance of the photosensitive layer within a wavelength range of the light exposure should be 1.0×10⁻³ to 1.0×10⁻¹. When the light transmittance is greater than 1.0×10⁻¹, the proportion of the irradiated light reaching the inner portion of the photosensitive layer is increased so that the resolution of a latent image may be reduced due to energy dispersion. When the light transmittance is less than 1.0×10⁻³, the charge transporting material or the charge generating material may absorb the irradiated light very much. However, when the charge transporting material absorbs the irradiated light more than the charge generating material does, the photosensitivity is reduced because the proportion of the irradiated light absorbed by the charge generating material decreases. Further, when the charge generating material absorbs the irradiated light more than the charge transporting material does, dark conductivity increases so that chargeability is reduced and stability is degraded. To obtain the proper light transmittance, the amount of the charge generating material should be optimized and a material having a low light absorbency within a wavelength of 380 to 450 nm should be selected as the charge transporting material.

In the electrophotographic imaging apparatus according to the present invention, conventional charging, light exposure, development, transferring, and fixing processes are performed, and a light source having an oscillation wavelength of 380 to 450 nm is used for the exposure. The light source is, for example, a GaN-based semiconductor laser or a light emitting diode.

In the electrophotographic imaging apparatus according to the present invention, since blue-violet light having an oscillation wavelength of 380 to 450 nm is used as a light source, the dispersion of irradiating light spot can be theoretically reduced to a half compared with a conventional light source, thereby being able to obtain a high resolution image. The electrophotographic photoreceptor used in the electrophotographic imaging apparatus includes the charge generating material on the light incident surface of the photosensitive layer so that its photosensitive layer configuration is advantageous to obtain images with high resolution. In a conventional multilayer type electrophotographic photoreceptor used in an electrophotographic imaging apparatus using a laser light source as an exposure light source, since a charge generating layer thereof is disposed near to a substrate, charges generated by the light radiation drift through a charge transporting layer disposed on the charge generating layer to the surface of the charge transporting layer and neutralize charges to form a latent image. Thus, charge diffusion caused by the charge migration inevitably occurs and results in a deterioration of the image resolution. In addition, when transmitting through the charge transporting layer to reach the charge generating layer, the radiating light tends to be dispersed because of, for example, refraction or scattering. Meanwhile, since the electrophotographic photoreceptor according to the present invention includes the charge generating material and the charge transporting material on a light incident surface, charges are generated near the surface of the photosensitive layer, and the generated charges instantly neutralize charges of opposite polarity generated on the surface of the photosensitive layer so that the charge loss due to the distant charge migration significantly decreases, and record information can be substantially reflected on a latent image.

According to the electrophotographic photoreceptor of the present invention, the light transmittance of a light source used is set in a predetermined range so that the degradation of the image resolution caused by the photoreceptor can be minimized and good photosensitive and mechanical properties can be provided. Accordingly, the photoreceptor according to the present invention is specifically effective as an electrophotographic photoreceptor for a blue-violet light source.

Hereinafter, the present invention will be described in detail with reference to Examples, but the present invention is not limited thereto.

### EXAMPLE 1

2 parts by weight of α-titanyl phthalocyanine and 2 parts by weight of polycarbonate Z resin (PANLITE TS-2020, Teijin Kasei Co.) were mixed with 46 parts by weight of chlorobenzene. The mixture was milled for an 1 hour using a sand mill to be finely dispersed.

parts by weight of arylamine-based compound (1), as a hole transporting material, 15 parts by weight of naphthalenetetracarboxylic acid diimide-based compound (2), as an electron transporting material, and 50 parts by weight of polycarbonate Z resin were dissolved in 300 parts by weight of chloroform.

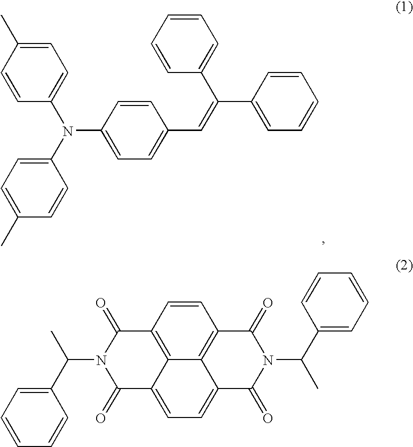

The dispersion and the solution were mixed at a weight ratio of 1:8. The mixture was dispersed to be homogeneous using a homogenizer, thereby obtaining a coating slurry for forming the photosensitive layer. The coating slurry was applied on an anodized aluminum drum (anodic oxide layer thickness: 5 μm) having a diameter of 30 mm using a ring bar and then dried, thereby obtaining a monolayer type electrophotographic photoreceptor drum having a thickness of about 15 μm. The photosensitive layer of the photoreceptor was exfoliated, and then the light transmittance at a wavelength of 405 nm thereof was measured using ultraviolet-visible ray absorption spectrometer. The measured light transmittance was 7.5×10⁻².

### EXAMPLE 2

A photoreceptor drum was manufactured using the same method of Example 1 except that the weight ratio of the dispersion and the solution was 1:4. The measured light transmittance at a wave length of 405 nm was 5.5×10⁻².

### EXAMPLE 3

40 parts by weight of the arylamine-based compound (1) as a hole transporting material, 60 parts by weight of polycarbonate Z resin were dissolved in 300 parts by weight of chloroform, thereby obtaining a solution for forming the charge transporting layer. The solution was applied on an anodized aluminum drum (anodic oxide layer thickness: 5 μm) having a diameter of 30 mm using a ring bar, and then dried, thereby obtaining charge transporting layer having a thickness of about 8 μm.

The dispersion and the solution used in Example 1 were mixed at a weight ratio of 1:2, thereby obtaining a dispersion for forming the charge generating layer. Next, the dispersion was applied on the charge transporting layer using the ring bar, and then dried, thereby forming a charge generating layer having a thickness of about 7 μm.

The light transmittance of the obtained multilayer type electrophotographic photoreceptor drum at a wavelength of 405 nm was 8.9×10⁻².

### COMPARATIVE EXAMPLE 1

A photoreceptor drum was manufactured using the same method of Example 1 except that diphenoquinone compound (3) was used instead of the compound (2) as an electron transporting material.

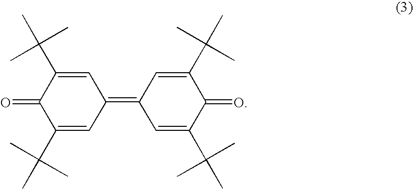

The light transmittance of the obtained photoreceptor at a wavelength of 405 nm was 3.2×10⁻⁴.

### COMPARATIVE EXAMPLE 2

A photoreceptor drum was manufactured using the same method of Example 1 except that the weight ratio of the dispersion and the solution of Example 1 was 1:20. The light transmittance of the obtained photoreceptor at a wavelength of 405 nm was 2.4×10⁻¹.

Image Evaluation

The photoreceptor drums manufactured in Examples 1˜3 and Comparative Examples 1˜2 were mounted in a modified commercial laser printer, and then images printed thereby were evaluated. The characteristics of the modified printer was as follows.

(+) corona charging mode, inversion developing mode,

a pilot LSU (laser scanning unit) having a 405 nm GaN semiconductor laser as a light source,

laser beam spot diameter: about 20 μm,

printing speed: 16 sheets/minute

resolution: 1200 dpi (dot per inch).

Using the above-described conditions, black and white fine lines and dot images consisting of dots were printed, and the printed images were magnified using a microscope, and then the dot reproducibility was evaluated. The image density (ID) of a square solid image having a side of 10 mm was measured using a density measurement apparatus (RD-900, Gretag Macbeth Co.).

The results are shown in Table 1.

TABLE 1

| | | | | Com- | |
|---|---|---|---|---|---|
| | | | | parative | Comparative |
| | Example 1 | Example 2 | Example 3 | Example 1 | Example 2 |
| Light | 7.5 × 10⁻² | 5.5 × 10⁻³ | 8.9 × 10⁻² | 3.2 × 10⁻⁴ | 2.4 × 10⁻¹ |
| transmit- | | | | | |
| tance | | | | | |
| Dot | good | good | good | missing | Blurred due |
| reproduc- | | | | dots | to toner |
| ibility | | | | | dispersion |
| Fine line | good | good | good | good | Blurred due |
| reproduc- | | | | | to toner |
| ibility | | | | | dispersion |
| Image | 1.36 | 1.42 | 1.32 | 1.27 | 0.98 |
| density | | | | | |

Referring to Table 1, the photoreceptors of Examples 1 through 3 according to the present invention showed excellent image forming properties, compared with the photoreceptors of Comparative Examples 1˜2. Based on the evaluation of the light transmittance, the photoreceptor of Comparative Example 1, which corresponds to the photoreceptor disclosed in the Examples of Japanese Laid-Open Patent Application Hei 9-240051 and has a difference only in the electron transporting material structure, shows a significantly low light transmittance in the light exposure wavelength, compared with Example 1 and 2. In addition, since the light absorbance was mainly made by the electron transporting material, it was insufficient for high quality images having high resolution to be obtained in the blue-violet light exposure wavelength. The missing dots in Comparative Example 1 are thought to be caused by the increase of half-tone voltages. This indicates that the decrease of charge generating efficiency is occurred by the increase of the light absorption ratio by the electron transporting material. Meanwhile, although the photoreceptor of Comparative Example 2 showed a greater light transmittance than those of Examples 1˜3 according to the present invention, it showed the low image density value and resolution degradation so that it is insufficient for a desired photoreceptor.

According to the above descriptions, the electrophotographic imaging apparatus according to the present invention uses blue-violet light having an oscillation wavelength of 380 to 450 nm as a light source, the dispersion of radiating light spots are significantly reduced, thereby being able to obtain high resolution effectively. In addition, the electrophotographic photoreceptor according to the present invention used with the laser exposure light source of blue-violet light includes the charge generating material on the light incident surface of the photosensitive layer thereof, thereby being able to obtain high resolution effectively in view of the structure of the photosensitive layer. In addition, in the electrophotographic photoreceptor according to the present invention, the light transmittance of the oscillation wavelength of the exposure light source is set in a predetermined range so that the resolution degradation due to the photoreceptor can be minimized and good photosensitive and mechanical properties can be provided. Accordingly, the photoreceptor according to the present invention is specifically effective as an electrophotographic photoreceptor for a blue-violet light source.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An electrophotographic photoreceptor comprising an electrically conductive substrate and a photosensitive layer formed on the electrically conductive substrate, wherein a latent image is formed on the photosensitive layer using a blue-violet exposure light source having a wavelength of about 380 to about 450 nm, an outer surface of the photosensitive layer includes a charge generating material, a charge transporting material, and a binder resin, and the light transmittance of the photosensitive layer is 1.0×10⁻¹ to 1.0×10⁻³ in the light exposure wavelength.

2. The electrophotographic photoreceptor of claim 1, wherein the photosensitive layer is a monolayer type photosensitive layer, and comprises the charge generating material and the charge transporting material dispersed or dissolved in the binder resin.

3. The electrophotographic photoreceptor of claim 1, wherein the photosensitive layer is a multilayer type photosensitive layer, and comprises:
a charge transporting layer having the charge transporting material dispersed or dissolved in the binder resin; and
a charge generating layer which is formed on the charge transporting layer and has the charge generating material and the charge transporting material dispersed or dissolved in the binder resin.

4. The electrophotographic photoreceptor of claim 1, wherein the charge generating material comprises a titanyl phthalocyanine-based compound, and wherein the charge transporting material comprises together a hole transporting material comprising an arylamine-based compound, and an electron transporting material comprising a naphthalenetetracarboxylic acid diimide-based compound.

5. An electrophotographic imaging apparatus comprising:
an electrophotographic photoreceptor having an electrically conductive substrate and a photosensitive layer formed on the electrically conductive substrate;
a charging apparatus for charging the photosensitive layer of the electrophotographic photoreceptor;
a light exposure apparatus forming an electrostatic latent image on the surface of the photosensitive layer of the electrophotographic photoreceptor by light exposure using a laser; and
a developing apparatus developing the electrostatic latent image,
wherein the latent image is formed on the photosensitive layer using a blue-violet exposure light source having a wavelength of about 380 to about 450 nm, the outer surface of the photosensitive layer includes a charge generating material, a charge transporting material, and a binder resin, and the light transmittance of the photosensitive layer 1.0×10⁻¹ to 1.0×10⁻³ in the light exposure wavelength.

6. The electrophotographic imaging apparatus of claim 5, wherein the photosensitive layer is a monolayer type photosensitive layer, and comprises the charge generating material and the charge transporting material dispersed or dissolved in the binder resin.

7. The electrophotographic imaging apparatus of claim 5, wherein the photosensitive layer is a multilayer type photosensitive layer, and comprises:
a charge transporting layer having the charge transporting material dispersed or dissolved in the binder resin; and
a charge generating layer which is formed on the charge transporting layer and has the charge generating material and the charge transporting material dispersed or dissolved in the binder resin.

8. The electrophotographic imaging apparatus of claim 5, wherein the charge generating material comprises a titanylphthalocyanine-based compound, and wherein the charge transporting material comprises together a hole transporting material comprising an arylamine-based compound, and an electron transporting material comprising a naphthalenetetracarboxylic acid diimide-based compound.
